(19) United States
(12) Patent Application Publication
(10) Pub. No.: US 2016/0041879 A1
(43) Pub. Date: Feb. 11, 2016

(54) DATA BACKUP TO AND RESTORE FROM TRUSTED DEVICES

(71) Applicant: MOTOROLA MOBILITY LLC, Chicago, IL (US)

(72) Inventors: Akila Varadarajan, San Jose, CA (US); Jagadish Kumar Agrawal, Santa Clara, CA (US); Sujoy Das, Grayslake, IL (US); Nathan J. Fortin, Morgan Hill, CA (US); Jordan Andrew Hurwich, Palo Alto, CA (US); Catherine T. Nguyen, Mountain View, CA (US); Peeyush Ranjan, Palo Alto, CA (US); Punit S. Soni, Mountain View, CA (US)

(21) Appl. No.: 14/452,974

(22) Filed: Aug. 6, 2014

(51) Int. Cl. G06F 11/14; H04L 29/08

(52) U.S. Cl. CPC G06F 11/1412; H04L 67/06

(57) ABSTRACT

Multiple computing devices (102, 122) transfer data and otherwise communicate directly with one another, and do so in the absence of any intervening devices such as devices accessed over the Internet or other wide-range network. A user of a particular device can select which other devices, if any, are to be trusted by the particular device. Once another device is trusted by the particular device, data from the particular device is backed up to the trusted device while the two devices are in close physical proximity to one another. In the event that data on the particular device is lost, the lost data can be restored from the trusted device to the particular device while the two devices are in close physical proximity to one another.

### BACKGROUND

As technology has advanced, the number and types of computing devices available has increased. This has resulted in users increasingly relying on their computing devices to store data as well as provide various functionality to assist or entertain users. As user reliance on their computing devices has increased, the importance to users of not losing the data they have stored on their computing devices has similarly increased. Although some devices may back up their data to services over the Internet, situations can arise in which such backing up of data is not performed. Such situations can leave users susceptible to the loss of data that has not been backed up.

### BRIEF DESCRIPTION OF THE DRAWINGS

Embodiments of data backup to and restore from trusted devices in close physical proximity are described with reference to the following drawings. The same numbers are used throughout the drawings to reference like features and components:

FIG. 1 illustrates an example system implementing the data backup to and restore from trusted devices in close physical proximity in accordance with one or more embodiments;

FIG. 2 illustrates an example process for implementing data backup to and restore from trusted devices in close physical proximity in accordance with one or more embodiments;

FIG. 3 illustrates an example environment in which the data backup to and restore from trusted devices in close physical proximity can be used in accordance with one or more embodiments;

FIG. 4 illustrates another example environment in which the data backup to and restore from trusted devices in close physical proximity can be used in accordance with one or more embodiments;

FIG. 5 illustrates another example process for implementing data backup to and restore from trusted devices in close physical proximity in accordance with one or more embodiments; and

FIG. 6 illustrates an example electronic device that can implement embodiments of the techniques discussed herein.

### DETAILED DESCRIPTION

Data backup to and restore from trusted devices in close physical proximity is discussed herein. Devices can communicate with one another using a mesh network, which allows the devices to transfer data and otherwise communicate directly with one another. Transferring data or communicating directly refers to transferring data or communicating in the absence of any intervening devices such as devices accessed over the Internet or other wide-range network. A user of a particular device can select which other devices, if any, are to be trusted by the particular device. Once another device is trusted by the particular device, data from the particular device is backed up to the trusted device while the two devices are in close physical proximity to one another. The trusted device stores the backed up data, and in the event that the data on the particular device is lost, the lost data can be restored from the trusted device to the particular device while the two devices are in close physical proximity to one another. A device having its data backed up is protected against data loss as the backed up data can be restored to the device, and thus is also referred to as a protected device.

Various memory management controls can be implemented by the protected device, the trusted device, or both the backed up and trusted devices. These memory management controls operate to prevent the trusted device from being overburdened with data that the trusted device is backing up for one or more other devices. Various different memory management controls can be implemented, such as specifying characteristics of data that is backed up (e.g., types of data files, age of data files, etc.), an amount of storage space in the trusted device that is allocated for data that is backed up, and so forth as discussed in more detail below.

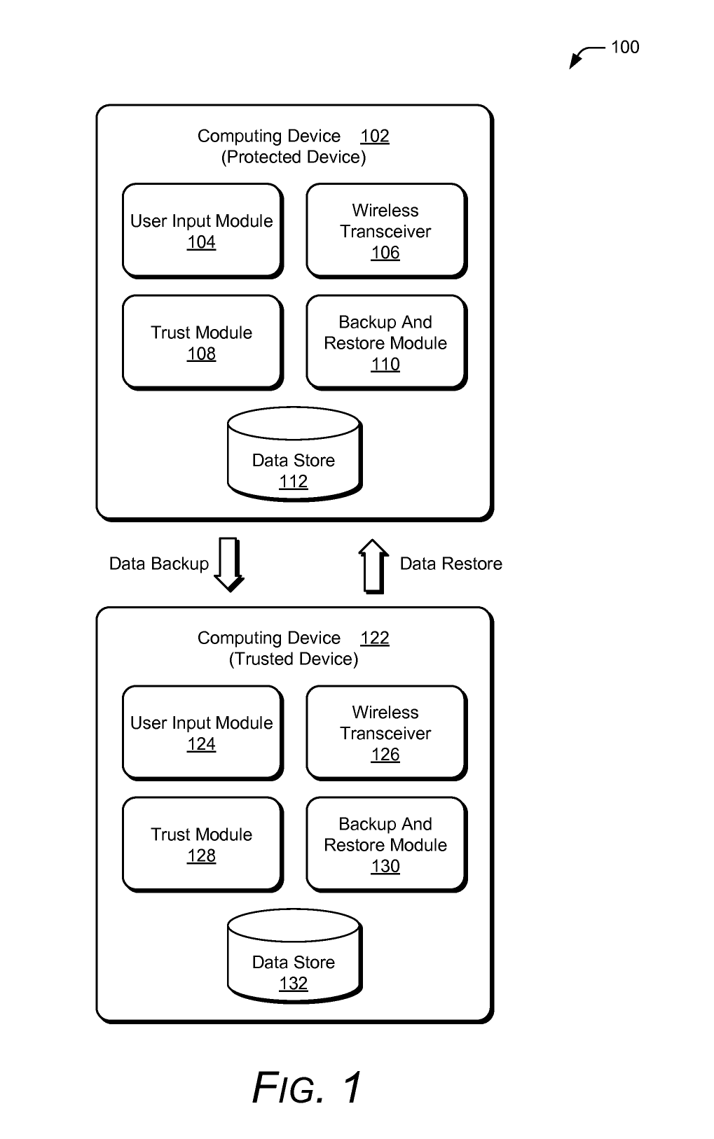

FIG. 1 illustrates an example system 100 implementing the data backup to and restore from trusted devices in close physical proximity in accordance with one or more embodiments. The system 100 includes a computing device 102 and a computing device 122, each of which can be any of a variety of different types of devices, such as a laptop computer, a cellular or other wireless phone, a tablet computer, an entertainment device, an audio and/or video playback device, a wearable device (e.g., eyeglasses, watch, other jewelry, etc.), and so forth. The computing devices 102 and 122 are each typically devices intended to be moved during use (e.g., a mobile device such as a wireless phone, tablet computer, etc.), although can alternatively be a device intended to remain stationary during use (e.g., a desktop computer). The computing devices 102 and 122 can be the same or different types of devices. The computing device 102 is also referred to as a protected device and the computing device 122 is also referred to as a trusted device, with data being backed up from the protected device (the computing device 102) to the trusted device (the computing device 122), and data being restored from the trusted device to the protected device.

The computing device 102 includes a user input module 104, a wireless transceiver 106, a trust module 108, a backup and restore module 110, and a data store 112. Similarly, the computing device 122 includes a user input module 124, a wireless transceiver 126, a trust module 128, a backup and restore module 130, and a data store 132.

Each user input module 104, 124 allows user inputs that request various different functionality be performed to be provided to the computing device 102, 122 that includes the user input module 104, 124. The user inputs can take various forms, such as actuation of a physical button or switch of the computing device, selection of an icon or other object displayed on a screen of the computing device, a particular touch sequence or pattern traced on or over a touchscreen of the computing device, an audible input received by a microphone of the computing device, a movement or sequence of movements (e.g., also referred to as a gesture) of the computing device detected by the computing device (e.g., detected by accelerometers or gyroscopes of the computing device), placing the computing device in physical contact with another computing device (e.g., tapping one computing device to another, laying one computing device on another), and so forth.

Each wireless transceiver 106, 126 can be any type of transceiver configured to wirelessly communicate with other computing devices using a mesh network. A mesh network refers to computing devices communicating with one another using communication protocols allowing direct communication between computing devices rather than communication via the Internet or other centralized service. Using the techniques discussed herein, data is backed up from the computing device 102 to the computing device 122, and restored from the computing device 122 to the computing device 102, wirelessly using a mesh network—the computing devices 102 and 122 communicate wirelessly with one another directly and in the absence of using the Internet or other centralized service.

The trust module 108 maintains a record of which other devices (if any) are trusted devices of the computing device 102, and a record of other devices (if any) for which the computing device 102 is a trusted device. The trust module 108 also manages allowing a user of the computing device 102 to identify other computing devices that are to be trusted devices of the computing device 102. Similarly, the trust module 128 maintains a record of which other devices (if any) are trusted devices of the computing device 122, and a record of other devices (if any) for which the computing device 122 is a trusted device. The trust module 128 also manages allowing a user of the computing device 122 to identify other computing devices that are to be trusted devices of the computing device 122.

Each backup and restore module 110, 130 manages the backing up of data from the computing device 102, 122 to a trusted device, and restoring data from a trusted device to the computing device 102, 122. The backup and restore module 110 also manages the storage of backup data from another computing device (for which the computing device 102, 122 is a trusted device) and the restoring of backed up data to another computing device (for which the computing device 102, 122 is a trusted device). For example, the backup and restore module 110 manages, for the computing device 102, the backup of data from the computing device 102 to the computing device 122 and the restoring of data from the computing device 122 to the computing device 102. The backup and restore module 130 manages, for the computing device 122, the backup of data from the computing device 102 to the computing device 122 and the restoring of data from the computing device 122 to the computing device 102.

The data store 112 stores data of the computing device 102 and can optionally store data backed up from one or more other devices. Similarly, the data store 132 stores data of the computing device 122 and can optionally store data backed up from one or more other devices. Each data store 112, 132 can be implemented in any of a variety of volatile or nonvolatile memories, such as random access memory (RAM), Flash memory, magnetic disks, optical discs, combinations thereof, and so forth.

Although various different individual modules and components 104-112 and 124-132 are illustrated, multiple ones of the modules or components 104-112 and 124-132 can be combined into a single module, functionality of one or more of the modules or components 104-112 and 124-132 can be implemented by another of the modules or components 104-112 and 124-132, one or more of the modules or components 104-112 and 124-132 can be separated into multiple modules or components, and so forth. For example, the trust module 108 can be implemented at least in part in the backup and restore module 110. The modules or components 104-112 and 124-132 can each be implemented in software, firmware, hardware, or combinations thereof.

During operation, the computing device 122 is a trusted device of the computing device 102. When the computing devices 102 and 122 are in close physical proximity to one another, data is backed up from the computing device 102 to the computing device 122, or alternatively restored from the computing device 122 to the computing device 102. This backing up and restoring of data while the computing devices 102, 122 are in close physical proximity is discussed in more detail below.

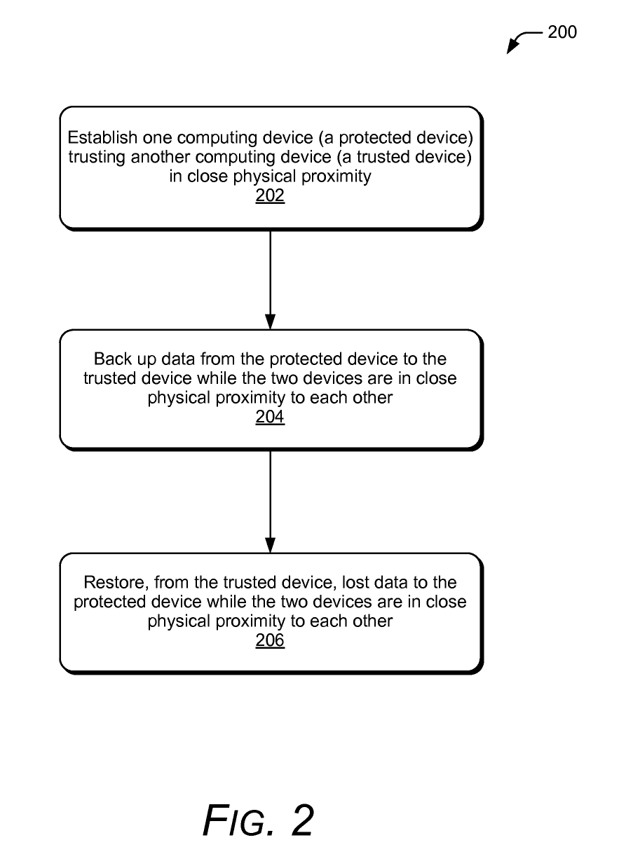

FIG. 2 illustrates an example process 200 for implementing data backup to and restore from trusted devices in close physical proximity in accordance with one or more embodiments. The process 200 is carried out at least in part by a computing device such as the computing device 102 or 122 of FIG. 1, and can be implemented in software, firmware, hardware, or combinations thereof. The process 200 is shown as a set of acts and is not limited to the order shown for performing the operations of the various acts. The process 200 is an example process for implementing data backup to and restore from trusted devices in close physical proximity; additional discussions of implementing data backup to and restore from trusted devices in close physical proximity are included herein with reference to different figures.

In the process 200, one computing device (the protected device) is established as trusting another computing device (the trusted device) in close physical proximity (act 202). The two computing devices being in close physical proximity refers to the two computing devices being physically close enough to one another to communicate with one another via a short-range communication protocol. A short-range communication protocol refers to a communication protocol that is intended for communication over short distances (e.g., less than a threshold distance, such as 300 feet, 10 feet, 6 inches and so forth).

Various different short-range communication protocols can be used with the techniques discussed herein. In one or more embodiments, the computing devices communicate with one another using a Wi-Fi communication protocol, such as a communication protocol adhering to any of the family of IEEE 802.11 standards, such as IEEE 802.11g (2003), IEEE 802.11n (2009), IEEE 802.11ac (2013), and so forth.

Alternatively, the computing devices can communicate with one another using a Bluetooth or Bluetooth low energy communication protocol. For example, these communication protocols can be protocols adhering to the Bluetooth Core Specification version 4.0 adopted Jun. 30, 2010 (Bluetooth 4.0) or the Bluetooth Core Specification version 4.1 adopted Dec. 3, 2013 (Bluetooth 4.1).

Alternatively, the computing devices can communicate with one another using a near-field communication protocol. For example, these communication protocols can be protocols adhering to the ISO/IEC 18000-3 (2010) standard, the ISO/IEC 18092 (2013) standard, the ECMA-340 (2013) standard, the ISO/IEC 21481 (2012) standard, or the ECMA 352 (2013) standard.

Data from the protected device is backed up to the trusted device while the two devices are in close physical proximity to one another (act 204). The data being backed up is communicated from the protected device to the trusted device directly using a short-range communication protocol as discussed above. No access to the Internet or other wide-area network or service to communicate data, to determine what data is to be communicated, and so forth is made.

Situations can arise in which the backed up data is subsequently lost from the protected device. Such data can be lost for a variety of different reasons, such as accidental deletion by the user, accidental or intentional corruption, malfunctioning hardware or software, and so forth. In such situations, the lost data is restored from the trusted device to the protected device while the two devices are in close physical proximity to each other (act 206).

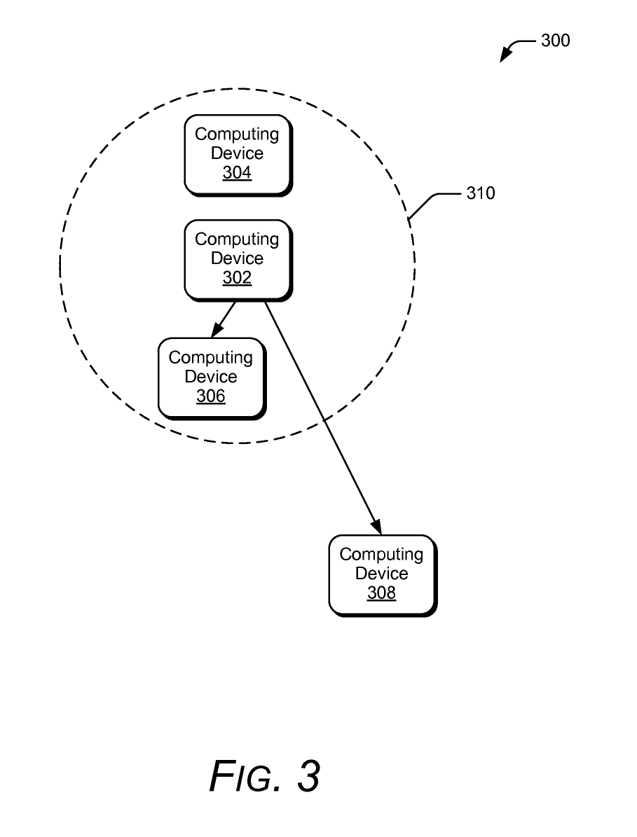

FIG. 3 illustrates an example environment 300 in which the data backup to and restore from trusted devices in close physical proximity can be used in accordance with one or more embodiments. The environment 300 illustrates example computing devices 302, 304, 306, and 308, each of which can be a computing device 102 or 122 of FIG. 1, at a particular point in time. The computing devices 302-308 are typically mobile computing devices, although one or more can alternatively be a stationary computing device. The computing device 302 implements a short-range communication protocol having a range illustrated by dashed line 310. The computing devices 304 and 306 are within the range illustrated by the dashed line 310, and thus are in close physical proximity to the computing device 302. Computing device 308 is not within the range illustrated by the dashed line 310, and thus computing device 308 is not in close physical proximity to the computing device 302. It should be noted that the devices 302-308 can each move over time, so which computing devices are within the range illustrated by the dashed line 310 can change over time. As the computing device 302 can change over time, the range illustrated by the dashed line 310 can also change over time.

The computing device 302 is a protected device, and has as trusted devices the computing devices 306 and 308. Thus, as the computing device 306 is in close physical proximity to the computing device 302, data being backed up can be communicated from the computing device 302 to the computing device 306 at the time illustrated in FIG. 3. However, as the computing device 308 is not in close physical proximity to the computing device 302 at the time illustrated in FIG. 3, data being backed up is not communicated from the computing device 302 to the computing device 308 at the time illustrated in FIG. 3. Although data being backed up is not communicated from the computing device 302 to the computing device 308 at the time illustrated in FIG. 3, data previously communicated from the computing device 302 to the computing device 308 is still stored by the computing device 308 at the time illustrated in FIG. 3. Furthermore, if the computing device 308 were to come into close physical proximity to the computing device 302 at a later time, data being backed up can be communicated from the computing device 302 to the computing device 308 at that later time. Additionally, although the computing device 304 is in close physical proximity to the computing device 302, the computing device 304 is not a trusted device for the computing device 302 and thus data is not backed up from the computing device 302 to the computing device 304.

Although the computing device 302 is discussed in FIG. 3 as being the protected device, it should be noted that each of the computing devices 304, 306, and 308 can also be a protected device. Each of the computing devices 304, 306, and 308 can have as a trusted device one or more of the computing devices 302, 304, 306, and 308, or alternatively one or more additional computing devices (not shown).

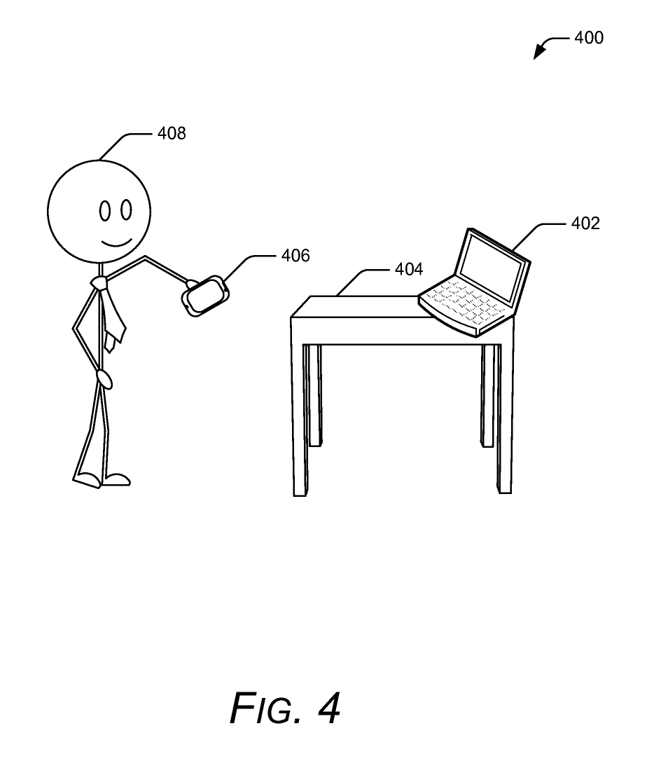

FIG. 4 illustrates another example environment 400 in which the data backup to and restore from trusted devices in close physical proximity can be used in accordance with one or more embodiments. The environment 400 illustrates, at a particular point in time, a laptop 402 sitting on a table 404, and a smartphone 406 being held by a user 408. Each of the laptop 402 and the smartphone 406 can be a computing device 102 or 122 of FIG. 1. As the user 408 approaches the table 404, the smartphone 406 and the laptop 402 come in close physical proximity to one another.

The smartphone 406 is a protected device and has as a trusted device the laptop 402. Thus, while the smartphone 406 is in close physical proximity to the laptop 402, data being backed up can be communicated from the smartphone 406 to the laptop 402. However, if the user were to walk away from the table 404, resulting in the smartphone 406 no longer being in close physical proximity to the laptop 402, data being backed up would no longer be communicated from the smartphone 406 to the laptop 402 (until the smartphone 406 and the laptop 402 are again in close physical proximity to one another).

In the discussions herein, reference is made to identifiers of computing devices (e.g., an identifier of a trusted device or an identifier of a protected device). In one or more embodiments, the identifier of a computing device is an identifier of the physical computing device itself, allowing different computing devices to be distinguished from one another. The identifier of the physical computing device can take various forms, such as a name assigned to the physical computing device, a media access control (MAC) address of the physical computing device or of a wireless transceiver of the computing device, and so forth. Alternatively, the identifier of a computing device at a particular time can be an identifier of a user logged into or otherwise authorized to use the computing device at that particular time. The identifier of the user can optionally be associated with an online service, allowing the user to access an account associated with his or her user identifier from various different computing devices.

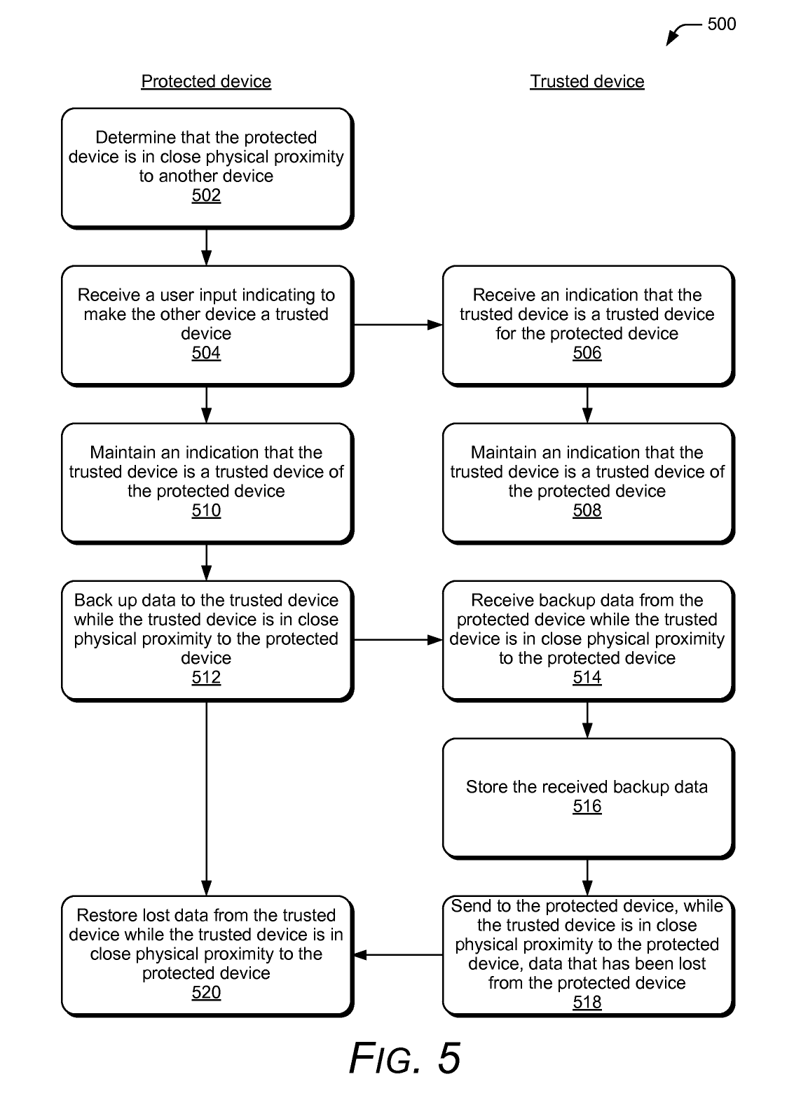

FIG. 5 illustrates an example process 500 for implementing data backup to and restore from trusted devices in close physical proximity in accordance with one or more embodiments. The process 500 illustrates the process 200 of FIG. 2 in additional detail. The process 500 is carried out at least in part by a protected device (e.g., the computing device 102 of FIG. 1) and a trusted device (e.g., the computing device 122 of FIG. 1), and can be implemented in software, firmware, hardware, or combinations thereof. The process 500 is shown as a set of acts and is not limited to the order shown for performing the operations of the various acts. Acts of the process 500 implemented by a protected device are illustrated on the left-hand side of FIG. 5, and acts of the process 500 implemented by the trusted device are illustrated on the right-hand side of FIG. 5. The process 500 is an example process for implementing data backup to and restore from trusted devices in close physical proximity; additional discussions of implementing data backup to and restore from trusted devices in close physical proximity are included herein with reference to different figures.

In the process 500, the protected device determines that the protected device is in close physical proximity to another device (act 502). Although referred to as a protected device in FIG. 5, it should be noted that the protected device may not yet have any trusted devices and may not yet have backed up data to a trusted device.

A user input indicating to make the other device in close physical proximity a trusted device is received (act 504). The user input can take any of a variety of different forms as discussed above. In one or more embodiments, identifiers of other computing devices in close physical proximity to the protected device are displayed by the protected device, and a user selection of one of the displayed identifiers is received as the user input.

The making of the other device a trusted device in the act 504 can be a one-sided determination, with the protected device informing the other device that it is now a trusted device for the protected device. Alternatively, the making of the other device a trusted device in the act 504 can be a two-sided determination, with the protected device informing the other device that it is requested to be a trusted device. The other device can then accept or decline the request and return an indication of such to the protected device. If the request is accepted then the other device becomes a trusted device for the protected device, and if the request is declined then the other device does not become a trusted device for the protected device. The accepting or declining of the request can be performed automatically (e.g., based on memory management controls as discussed in more detail below) by the other device, or alternatively in response to user input at the other device. For example, a user of the other device can be prompted that a request to make the other device a trusted device for a particular protected device has been received, and the user can provide input indicating to accept or decline the request. If the request is declined, then the process 500 ends and the other device is not a trusted device for the protected device.

Assuming the other device is made a trusted device of the protected device, an indication of such is received by the trusted device (act 506). This indication can be the protected device informing the trusted device for a one-sided determination, or can be the request from the protected device for a two-sided determination. The trusted device also maintains an indication that the trusted device is a trusted device for the protected device (act 508). This maintained indication can take various forms, such as a list including an identifier of each protected device for which the trusted device is a trusted device.

Additionally, the protected device maintains an indication that the trusted device is a trusted device for the protected device (act 510). This maintained indication can take various forms, such as a list including an identifier of each trusted device of the protected device. Because the indication of the trusted device is maintained, user input need not be provided to indicate that the trusted device is a trusted device each time the backed up and trusted devices are in close physical proximity to one another. Rather, data can be automatically backed up and restored without needing user input to indicate that the trusted device is indeed a trusted device.

Subsequently, while the protected device and the trusted device are in close physical proximity to one another, data is backed up from the protected device to the trusted device (act 512). The backed up data is sent by the protected device and received by the trusted device (act 514), which stores the received data (act 516) at the trusted device.

When backing up data from the protected device to the trusted device, synchronization information (e.g., various different data or other control information) can be maintained by the protected device, the trusted device, or both devices. This synchronization information allows tracking of which data has or has not yet been backed up. For example, situations can arise in which one or both of the trusted and protected devices move so that the devices are no longer in close physical proximity prior to all of the data being backed up to the trusted device. The synchronization information allows one or both of the backed up and trusted devices to determine which data has not yet been backed up, allowing such data to be backed up when the two devices are again in close physical proximity to one another.

In one or more embodiments, the data is automatically backed up whenever the trusted device and the protected device are in close physical proximity to one another. Alternatively, user input may be provided to initiate the backup of data or to pause the automatic backup of data. This allows the user of the protected device or user of the trusted device (or users of both devices) control over when the backup is performed. For example, in situations where the user of the protected device desires to conserve battery power, he or she can pause or otherwise interrupt the backing up of data. By way of another example, in situations where the user of the trusted device desires to allocate resources (e.g., data transfer bandwidth of the wireless transceiver) to other functionality, he or she can pause or otherwise interrupt the backing up of data.

After the data has been backed up to the trusted device, situations can arise in which the data is lost from the protected device as discussed above. In such embodiments, while the protected device and the trusted device are in close physical proximity to one another, the trusted device sends the data to the protected device (act 518), and the protected device restores the data by saving the data at the protected device (act 520).

In one or more embodiments, the trusted device is the device that initiates the restoring of data to the protected device. Situations can arise in which the data lost from the protected device includes the indications of the trusted devices, in which case the protected device would not know where to restore data from. The trusted device can automatically determine when the protected device has lost data, such as using the synchronization information discussed above. For example, the trusted device may expect particular data as part of the synchronization information, such as an acknowledgement by the protected device that it knows the trusted device is indeed a trusted device. The trusted device can interpret the lack of receipt of such particular data as an indication that the protected device has lost its data.

Alternatively, the protected device itself may initiate the restoring of data to the protected device. For example, situations may arise where the protected device has lost data but not data indicating which devices are trusted devices.

It should be noted that the protected device can make a trusted device an untrusted device at any time. Essentially, the protected device can revoke the trusted device status of any trusted device, indicating that the trusted device is no longer a trusted device. A trusted device can be made an untrusted device automatically (e.g., in response to various rules or criteria being satisfied), or in response to a user input requesting to make the device an untrusted device.

In response to a trusted device being made an untrusted device, the protected device sends an indication to the trusted device that the trusted device is no longer a trusted device for the protected device. This indication is sent when the protected device and the trusted device are next within close physical proximity of one another. In response to the indication, the trusted device deletes the data it is storing for the protected device, and deletes the indication that it is a trusted device for the protected device.

In one or more embodiments, all of the data of the protected device to be backed up is sent to the same trusted device. Such data can optionally be sent to multiple trusted devices, so each of the multiple trusted devices has a copy of the protected device's data. Alternatively, the data to be backed up can be can be separated into two or more groups of data, and different groups of data can be sent to different ones of multiple trusted devices. Each group of data can optionally be sent to multiple trusted devices. Thus, the resource burden of storing the backup data is spread across multiple trusted devices.

The techniques discussed herein refer to backing up data from the protected device to the trusted device. All data on the protected device can be backed up, or alternatively only a subset of the data on the protected device can be backed up. Various different characteristics of data can be used to determine which data is backed up. These characteristics can include location where the data is stored (e.g., data in particular folders or directories of the protected device are backed up but data in other folders or directories are not backed up), type of data (e.g., text and image data can be backed up but other types of data (e.g., audio data) are not backed up), size of data (e.g., only files of less than a threshold size are backed up), attributes of data (e.g., the data is marked as able to be shared or backed up), age of data (e.g., only data that satisfies a threshold value, such as being created or last modified within a threshold number of days or weeks, is backed up), how recently the data was used (e.g., only data that satisfies a threshold value, such as having been opened or otherwise accessed within a threshold number of days or weeks, is backed up), and so forth.

User input specifying one or more characteristics of data can optionally be received, allowing a user of the protected device to specify which data is to be backed up. For example, the user input can be user selection of particular files to be marked as able to be backed up, user selection of particular types of data that is to be backed up, user selection of an age of data to be backed up, and so forth.

In one or more embodiments, various memory management controls are implemented by the protected device to prevent the trusted device from being overburdened with data from the protected device. This overburdening can include using an excess of resources of the trusted device, such as more than a threshold amount of memory, more than a threshold amount of data transfer bandwidth, and so forth. These memory management controls use various different characteristics of the data to limit or restrict amounts or types of data that are backed up to the trusted device. These characteristics can include, for example, the size of data (e.g., only files of less than a threshold size are backed up), age of data (e.g., only data that satisfies a threshold value, such as being created or last modified within a threshold number of days or weeks, is backed up), how recently the data was used (e.g., only data that satisfies a threshold value, such as having been opened or otherwise accessed within a threshold number of days or weeks, is backed up), and so forth.

Additionally or alternatively, various memory management controls can be implemented by the trusted device to prevent the trusted device from being overburdened with data from the protected device. These memory management controls use various different characteristics of the data to limit or restrict amounts or types of data that are backed up to the trusted device. These characteristics can include type of data (e.g., text and image data can be backed up but other types of data (e.g., audio data) are not backed up), size of data (e.g., only files of less than a threshold size are backed up), age of data (e.g., only data that satisfies a threshold value, such as being created or last modified within a threshold number of days or weeks, is backed up), how recently the data was used (e.g., only data that satisfies a threshold value, such as having been opened or otherwise accessed within a threshold number of days or weeks, is backed up), and so forth.

These memory management controls of the trusted device can also operate to limit or restrict an amount of resources of the trusted device that can be used to store data from one or more protected devices, such as an amount of storage space on the trusted device, an amount of data transfer bandwidth (based on the communication protocol being used, capabilities of the wireless transceiver of the trusted device, current power state of the trusted device, etc.), and so forth. The trusted device can specify an amount of resource usage (e.g., a particular number of megabytes or gigabytes that can be used to store data backed up from a protected device, a particular number of megabytes per second that can be used to transfer data, etc.). The amount can be specified by a component or module of the trusted device, or by a user of the trusted device. The trusted device can send an indication of this amount of resource usage to the protected device, which can use various memory management controls to determine which data is backed up to the trusted device at what times so that the backing up of data does not result in the amount of resource usage being exceeded.

Additionally or alternatively, the trusted device itself can use various memory management controls to determine which data is backed up to the trusted device so that the backing up of data does not result in the amount of resource usage being exceeded. For example, if the amount of data backed up to the trusted device exceeds the specified amount of space, then backed up data is deleted from the trusted device so that the amount of backed up data stored on the device no longer exceeds the specified amount of space. Different rules or criteria can be used to determine which data is deleted from the trusted device, such as deleting the data in an order from largest file size to smallest file size, deleting data in an order from least recently backed up to most recently backed up, and so forth. By way of another example, the wireless transceiver of the trusted device can be configured to receive data from the protected device at not greater than a particular data transfer rate.

In the discussions herein, reference is made to restoring data to a protected device from which the data was previously backed up. Alternatively, data can be restored in an analogous manner to another device from which the data was not previously backed up. Data is restored to a different device by associating the protected device with that different device. This association can be made in various manners, such as by the user logging into the different device with the same identifier used to log into the protected device, by user input to the trusted device specifying that the different device is associated with the protected device, and so forth. Thus, for example, if a user were to have backed up his phone to a trusted device and subsequently break or lose his phone, the backed up data can be restored from the trusted device to a new phone purchased by the user.

The techniques discussed herein support various usage scenarios. For example, each member of a family may have a smartphone capable of taking pictures, and each family member's smartphone can be a trusted device of another family member's smartphone. If the family is vacationing together outside of the country, each smartphone can back up the pictures it takes to its trusted device, allowing the family's pictures to be backed up without incurring expensive data roaming charges by uploading pictures to a service via the Internet.

By way of another example, a person can have a tablet device and an automotive computer in his car that is a trusted device of the tablet. Data from the tablet can be backed up to the automotive computer each time the user enters his car with the tablet without requiring either the automotive computer or the tablet to access the Internet (or even be capable of accessing the Internet).

By way of another example, a person can have a smartphone and a desktop computer in his office that is a trusted device of the smartphone. Data from the smartphone can be backed up to the desktop computer each time the user enters his office with the smartphone without requiring either the desktop computer or the smartphone to access the Internet (or even be capable of accessing the Internet).

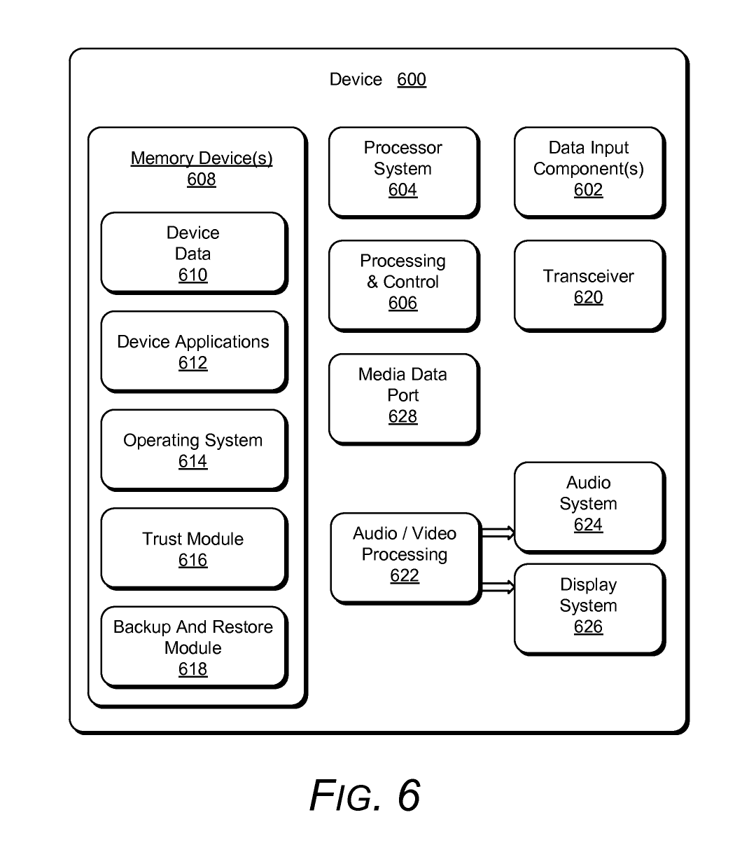

FIG. 6 illustrates various components of an example electronic device 600 that can be implemented as a computing device as described with reference to any of the previous FIGS. 1-5. The device 600 may be implemented as any one or combination of a fixed or mobile device in any form of a consumer, computer, portable, user, communication, phone, navigation, gaming, messaging, Web browsing, paging, media playback, or other type of electronic device, such as the computing device 102 or 122 described above.

The electronic device 600 can include one or more data input components 602 via which any type of data, media content, or inputs can be received such as user-selectable inputs, messages, music, television content, recorded video content, and any other type of audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 602 may also include various other input components such as microphones, touch sensors, keyboards, and so forth.

The electronic device 600 of this example includes a processor system 604 (e.g., any of microprocessors, controllers, and the like) or a processor and memory system (e.g., implemented in a system on a chip), which processes computer executable instructions to control operation of the device. A processing system may be implemented at least partially in hardware that can include components of an integrated circuit or on-chip system, an application specific integrated circuit, a field programmable gate array, a complex programmable logic device, and other implementations in silicon or other hardware. Alternatively or in addition, the electronic device 600 can be implemented with any one or combination of software, hardware, firmware, or fixed logic circuitry implemented in connection with processing and control circuits that are generally identified at 606. Although not shown, the electronic device can include a system bus or data transfer system that couples the various components within the device. A system bus can include any one or combination of different bus structures such as a memory bus or memory controller, a peripheral bus, a universal serial bus, or a processor or local bus that utilizes any of a variety of bus architectures.

The electronic device 600 also includes one or more memory devices 608 that enable data storage such as random access memory, nonvolatile memory (e.g., read only memory, flash memory, erasable programmable read only memory, electrically erasable programmable read only memory, etc.), and a disk storage device. A memory device 608 provides data storage mechanisms to store the device data 610, other types of information or data (e.g., data backed up from other devices), and various device applications 612 (e.g., software applications). For example, an operating system 614 can be maintained as software instructions with a memory device and executed by the processor system 604.

In one or more embodiments the electronic device 600 includes a trust module 616 as well as a backup and restore module 618 to implement the data backup to and restore from trusted devices in close physical proximity discussed herein. For example, trust module 616 can be the trust module 108 or 128 of FIG. 1, and backup and restore module 618 can be the backup and restore module 110 or 130 of FIG. 1. Although represented as a software implementation, the modules 616 and 618 may be implemented as any form of a control application, software application, signal processing and control module, firmware that is installed on the electronic device 600, a hardware implementation of the modules, and so on.

The electronic device 600 also includes a transceiver 620 that supports wireless communication with other devices or services allowing data and control information to be sent as well as received by the device 600. The wireless communication can be supported using any of a variety of different public or proprietary communication networks or protocols such as Wi-Fi protocols, Bluetooth protocols, and so forth. The transceiver 620 can include the wireless transceiver 106 of FIG. 1.

The electronic device 600 can also include an audio or video processing system 622 that processes audio data or passes through the audio and video data to an audio system 624 or to a display system 626. The audio system or the display system may include any devices that process, display, or otherwise render audio, video, display, or image data. Display data and audio signals can be communicated to an audio component or to a display component via a radio frequency link, S-video link, high definition multimedia interface (HDMI), composite video link, component video link, digital video interface, analog audio connection, or other similar communication link, such as media data port 628. In implementations the audio system or the display system are external components to the electronic device. Alternatively or in addition, the display system can be an integrated component of the example electronic device, such as part of an integrated touch interface.

Although embodiments of techniques for data backup to and restore from trusted devices in close physical proximity have been described in language specific to features or methods, the subject of the appended claims is not necessarily limited to the specific features or methods described. Rather, the specific features and methods are disclosed as example implementations of techniques for data backup to and restore from trusted devices in close physical proximity.

What is claimed is:

1. A method implemented in a first computing device, the method comprising:
determining that the first computing device is in close physical proximity to a second computing device;
receiving, at the first computing device, a user input indicating to make the second computing device a trusted device;
maintaining, at the first computing device, an indication that the second computing device is a trusted device; and
backing up, while the second computing device is in close physical proximity to the first computing device, data from the first computing device to the second computing device by wirelessly transferring the data directly from the first computing device to the second computing device.

2. The method of claim 1, the close physical proximity comprising the first and second computing devices being physically close enough to communicate with one another via a short-range communication protocol.

3. The method of claim 2, the short-range communication protocol comprising a Bluetooth communication protocol.

4. The method of claim 2, the short-range communication protocol comprising a Wi-Fi communication protocol.

5. The method of claim 2, the short-range communication protocol comprising a near-field communication protocol.

6. The method of claim 1, the wirelessly transferring the data directly from the first computing device to the second computing device comprising transferring the data from the first computing device to the second computing device in the absence of using the Internet or other centralized service.

7. The method of claim 1, further comprising:
determining, after an amount of time, that the second computing device is no longer in close physical proximity to the first computing device;
subsequently determining, after determining that the second computing device is no longer in close physical proximity to the first computing device, that the second computing device is again in close physical proximity to the first computing device; and
backing up, in response to the second computing device again being in close physical proximity to the first computing device, from the first computing device to the second computing device data that has not previously been backed up to the second computing device.

8. The method of claim 1, further comprising:
losing, after data from the first computing device has been backed up to the second computing device, the data from the first computing device;
subsequently receiving, in response to the second computing device being in close physical proximity to the first computing device, the data from the second computing device; and
storing, at the first computing device, the received data.

9. The method of claim 1, further comprising receiving user input at the first computing device indicating which data of the first computing device is to be backed up to the second computing device.

10. A first computing device comprising:
a wireless transceiver configured to communicate wirelessly with a second computing device while the first computing device is in close physical proximity to the second computing device, the wireless transceiver being configured to transfer data directly from the first computing device to the second computing device;
a user input module configured to receive a user selection to make the second computing device a trusted device;
a trust module configured to maintain an indication that the second computing device is a trusted device; and
a backup and restore module configured to back up, while the second computing device is in close physical proximity to the first computing device, data from the first computing device to the second computing device by transferring the data to the second computing device via the wireless transceiver.

11. The first computing device of claim 10, the wireless transceiver being configured to communicate data directly to the second computing device using a short-range communication protocol and in the absence of using the Internet or other centralized service.

12. The first computing device of claim 10, the backup and restore module being further configured to implement management controls to prevent the second computing device from becoming overburdened with backup data from the first computing device.

13. The first computing device of claim 10, further comprising:
the wireless transceiver being further configured to communicate wirelessly with a third computing device while the first computing device is in close physical proximity to the third computing device, the wireless transceiver being configured to transfer data directly from the first computing device to the third computing device;
the user input module being further configured to receive a user selection to make the third computing device a trusted device;
the trust module being further configured to maintain an indication that the third computing device is a trusted device; and
the backup and restore module being further configured to:
back up, while the second computing device is in close physical proximity to the first computing device, a first group of data from the first computing device to the second computing device by transferring the first group of data to the second computing device via the wireless transceiver, and
back up, while the third computing device is in close physical proximity to the first computing device, a second group of data from the first computing device to the third computing device by transferring the second group of data to the third computing device via the wireless transceiver, the first group of data and the second group of data being different groups of data.

14. A method comprising:
receiving, from a first computing device and at a second computing device, while the first computing device is in close physical proximity to the second computing device, an indication that the second computing device is a trusted device of the first computing device;
maintaining, at the second computing device, an indication that the second computing device is a trusted device of the first computing device;
receiving, while the second computing device is in close physical proximity to the first computing device and the second computing device is a trusted device of the first computing device, backup data from the first computing device, the receiving comprising wirelessly receiving the backup data directly from the first computing device; and
storing, at the second computing device, the received backup data.

15. The method of claim 14, the indication received from the first computing device comprising a request for the second computing device to be a trusted device of the first computing device, the method further comprising:
presenting at the second computing device an indication of the request;
receiving a user input indicating whether the second computing device is to be a trusted device of the first computing device; and
allowing the second computing device to be a trusted device of the first computing device in response to the user input indicating that the second computing device is to be a trusted device of the first computing device.

16. The method of claim 14, further comprising:
determining at the second computing device, while the second computing device is in close physical proximity to the first computing device, that data from the first computing device previously backed up to the second computing device has been lost from the first computing device; and
providing, from the second computing device, the data to the first computing device.

17. The method of claim 16, further comprising providing to the first computing device, from the second computing device, an indication that the second computing device is a trusted device of the first computing device.

18. The method of claim 14, the close physical proximity comprising the first and second computing devices being physically close enough to one another to communicate with one another via a short-range communication protocol.

19. The method of claim 14, further comprising implementing at the second computing device management controls to prevent the second computing device from becoming overburdened with backup data from the first computing device.

20. The method of claim 19, the management controls comprising limiting an amount of memory of the second computing device in which backup data from the first computing device can be stored.

21. The method of claim 19, the management control further comprising storing only data having an age that satisfies a threshold value.

22. A computing device comprising:
a wireless transceiver configured to wirelessly receive from an additional computing device, while the computing device is in close physical proximity to the additional computing device, an indication that the computing device is a trusted device of the additional computing device;
a trusted module configured to maintain, at the computing device, an indication that the computing device is a trusted device of the additional computing device;
the wireless transceiver being further configured to wirelessly receive, while the computing device is in close physical proximity to the additional computing device, backup data directly from the additional computing device; and
a backup and restore module configured to store, in a data store of the computing device, the received backup data.

23. The computing device of claim 22, the wireless transceiver being configured to receive data directly from the additional computing device using a short-range communication protocol and in the absence of using the Internet or other centralized service.

24. The computing device of claim 22, the backup and restore module being further configured to implement management controls to prevent the computing device from becoming overburdened with backup data from the additional computing device.
